(19) United States
(12) Patent Application Publication
(10) Pub. No.: US 2026/0004316 A1
(43) Pub. Date: Jan. 1, 2026

(54) DYNAMIC RETAIL ANALYTICS OPTIMIZATION PLATFORM

(71) Applicant: NCR Voyix Corporation, Atlanta, GA (US)

(72) Inventor: Itamar David Laserson, Givat Shmuel (IL)

(21) Appl. No.: 18/758,014

(22) Filed: Jun. 28, 2024

(51) Int. Cl. G06Q 30/0202; G06Q 30/0201

(52) U.S. Cl. CPC G06Q 30/0202; G06Q 30/0206

(57) ABSTRACT

A real-time, dynamic pricing optimization platform is provided to retailers, enabling immediate adjustment to pricing strategies based on current market conditions. Utilizing a multi-tenant database, the platform provides anonymized, up-to-date sales data across various regions and store formats. Platform features include real-time data updates, customizable benchmarking filters, anomaly detection, and seamless API integration with existing systems. The features empower retailers to respond swiftly to market changes, optimize pricing, and enhance competitiveness, thereby addressing limitations of traditional pricing strategies reliant on outdated data.

### BACKGROUND

In the rapidly evolving retail industry, pricing optimization remains a critical challenge, particularly with the advent of mobile commerce and real-time digital interactions influencing consumer behaviors. Traditional methods, relying on historical data, often fail to capture the dynamic nature of market conditions, leading to lost sales opportunities and reduced competitiveness. Current solutions, such as those provided by market research companies, typically offer insights based on data that is not only aggregated but also outdated, sometimes by weeks. This delay significantly hampers a retailer's ability to respond effectively to immediate market changes such as competitor promotions, viral marketing trends, or sudden shifts in consumer demand. Consequently, there is a pressing need for a solution that can provide real-time, actionable insights into market dynamics and consumer behavior, enabling retailers to optimize pricing strategies instantaneously and maintain a competitive edge in a highly volatile market environment.

### BRIEF DESCRIPTION OF THE DRAWINGS

FIG. 1 is a diagram of a system for a dynamic retail analytics platform, according to an example embodiment.

FIG. 2 is a diagram of a method for operating or providing a dynamic retail analytics platform according to an example embodiment.

FIG. 3 is a diagram of another method for operating or providing, according to an example embodiment.

### DETAILED DESCRIPTION

The retail sector has undergone significant transformation with the integration of digital technologies, which has dramatically altered consumer purchasing behaviors. Traditional pricing strategies, which often rely on historical sales data, are increasingly inadequate due to the dynamic nature of the market. Retailers face challenges in responding swiftly to changes such as competitor promotions, social media influences, and unexpected shifts in consumer demand. Existing solutions, like those offered by market research firms, typically provide insights based on data that is not only aggregated but also significantly delayed, rendering it nearly obsolete for real-time decision-making. This lag in data relevance directly impacts a retailer's ability to effectively adjust pricing strategies, potentially resulting in lost sales and diminished market competitiveness.

The embodiment of the invention presented herein address these challenges by introducing a real-time, dynamic pricing optimization platform specifically designed for the retail industry. This platform leverages advanced data analytics to provide immediate insights into product movements and sales trends across various stores and regions. By utilizing a multi-tenant database, the system allows retailers to access up-to-date information that reflects current market conditions, enabling them to make informed pricing decisions quickly.

Key platform features for the embodiments presented herein include:
Real-Time Data Updates: The platform continuously gathers and updates transaction and sales data, ensuring that the information remains current and highly relevant.
Anonymization and Data Security: Ensuring that individual retailer data remains confidential and secure, the platform aggregates data in such a way that specifics about individual transactions are not disclosed.
Customizable Benchmarking Filters: Retailers can tailor the data views according to specific needs such as regional trends, store formats, and cultural consumer behaviors, allowing for nuanced analysis and targeted pricing strategies.
Anomaly Detection: The system identifies and alerts retailers to unusual sales patterns in real-time, enabling immediate action to capitalize on opportunities or mitigate risks.
API Integration: The platform is designed to seamlessly integrate with existing retail management systems, enhancing its utility and ease of adoption without disrupting current operations.

This innovative approach not only enhances the responsiveness of retailers to market fluctuations but also significantly improves their ability to strategize and implement effective pricing policies, thereby increasing sales and maintaining competitiveness in a fast-paced market environment.

The term “user,” “store manager,” and/or “retail analyst” may be used interchangeably and synonymously herein and below. This refers to an individual who subscribes a given store or retailer to the platform and platform services discussed herein and below. The user interacts with the platform via a platform provided user interface (UI).

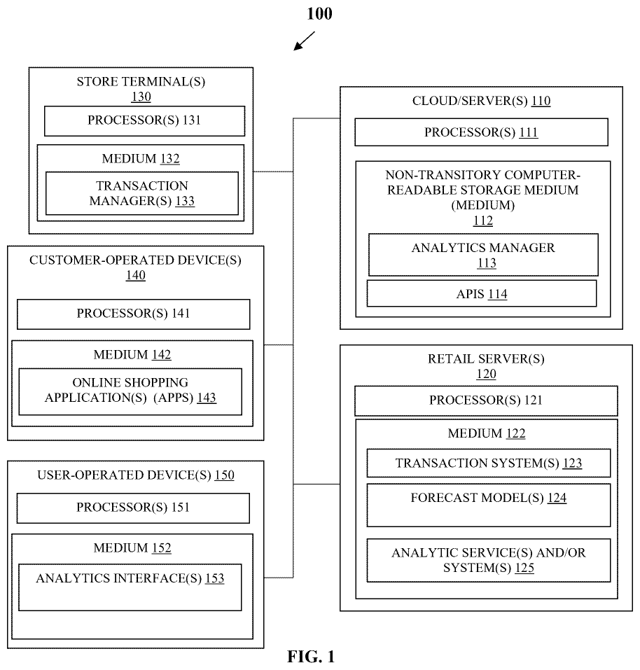

FIG. 1 is a diagram of a system 100 for a dynamic retail analytics platform, according to an example embodiment. Notably, the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of the dynamic retail analytics platform presented herein and below.

System 100 includes a cloud 110 (also referred to as “server” or “cloud server” herein), a plurality of retail servers 120, store terminals 130, customer-operated devices 140, and user-operated devices 150. Cloud 110 includes at least one processor 111 and a non-transitory computer-readable storage medium (“medium”) 112, which includes instructions for an analytics manager 113 and application programming interfaces (“APIs”) 114. The executable instructions when executed by the processor 111 cause processor 11 to perform operations discussed herein and below with respect to 113 and 114.

Each retail server 120 includes at least one processor 121 and a medium 112, which includes instructions for a transaction system 123, a forecast model 124, and analytics services and/or systems 125. The instructions when executed by the processor 121 cause the processor 121 to perform operations discussed herein and below with respect to 123-125.

Each store terminal 130 includes at least one processor 131 and a medium 132, which includes instructions for a transaction manager 133. The instructions when executed by the processor 131 cause the processor 131 to perform operations discussed herein and below with respect to 133.

Each customer-operated device 140 includes at least one processor 141 and a medium 142, which includes instructions for an analytics application (“app”) 143. The instructions when executed by the processor 141 cause the processor to perform operations discussed herein and below with respect to 143.

Each user-operated device 150 includes at least one processor 151 and a medium 152, which includes instructions for an analytics interface 153. The instructions when executed by the processor 151 cause the processor to perform operations discussed herein and below with respect to 153.

Initially, retailers subscribe for features and services associated with analytics manager 113. During registration, analytics manager 113 is given access to historical and real-time transaction data for stores of the retailers. The analytics manager 113 obtains the historical transaction data by interacting with transaction system 123 and/or an analytic service and/or system 125 using APIs 114. Analytics manager 113 obtains real-time transaction data from either a corresponding transaction system 123 or a transaction manager 133 using APIs 114.

In an embodiment, a customer of a given store or retailer performs transactions online via an online shopping app 143 on a customer-operated device 140. Analytics manager receives the real-time transaction data for an online transaction of a customer via a corresponding transaction system 123.

In an embodiment, a retailer maintains its historical and real-time transaction data in a network storage location which analytics manager 113 can access in real time. In this embodiment, analytics manager 113 uses APIs 114 to access and analyze the transaction data of the network storage location.

In an embodiment, a retailer also provides analytics manager 113 with access to its forecast model 124. The forecast model 124 provides item sales forecasts over given intervals of future time for the corresponding retailer. In an embodiment, the item sales forecasts are predicted sales by item and by store of the retailer predicted at the given intervals for a future time period. For example, a forecast model provides predicted branded soda item X sales at store Y of retailer Z at 10 minute intervals of time for a next calendar business week of store Y.

In an embodiment, a retailer further provides analytics manager 113 with access to a given store's product catalog. The product catalog includes, by way of example, only item UPCs and/or price lookup codes (PLCs) for its items, item classifications for the items, and pricing information for the items.

During registration, a user associated with a store or a given store of a retailer subscribes to the features and services offered by analytics manager 113 using analytics interface 153 of user-operated device 150 to interact with analytics manager 113. The user acknowledges use of and grants access to the retailer's historical and real-time transaction data, product catalogs, and corresponding forecast models 124 during a registration session.

During the registration session, the user also subscribes to receive real-time and dynamic pricing alerts based on benchmarks that the analytics manager 113 analyzes on behalf of the user's store and/or retailer. Analytics manager 113 presents a variety of user-selectable options and input fields within analytics interface 153 to the user during the registration session or during subsequent management sessions in which the user is changing previously registered information.

During registration session, the user identifies specific items that the user wants to be monitored by the analytics manager 113. The user also defines customized group criteria, which permits analytics manager 113 to cluster transaction data together from multiple different stores that satisfy the group criteria. Analytics manager 113 also begins to actively assemble real-time transaction data for the stores that meet the group criteria by monitoring corresponding transaction managers 133, transaction systems, and/or accessible network storage locations that include the real-time transaction as transactions are processed at the stores.

The analytics manager 113 actively monitors in real time each clustering of stores' transaction data which satisfy registered customized group criteria as a monitored cluster or a monitored group. For each monitored cluster, analytics manager 113 interacts with a corresponding store's forecast model to obtain item sales forecasts for a registered item being monitored within the monitored group.

For each monitored cluster, analytics manager 113 generates, updates, and maintains a current and actual recorded item sales mean distribution for a given monitored item per store as the corresponding transaction data is being generated and received in real time by analytics manager 133 from corresponding transaction managers 133 and transaction systems 123 for the stores of the monitored cluster. The analytics manager 113 also generates, updates, and maintains a current mean distribution of forecasted item sales for the monitored item by store. Additionally, the analytics manager 113 calculates, updates, and maintains a mean distribution of actual recorded item sales for a given monitored item associated with the group as a whole.

The analytics manager 113 evaluates each store's current and actual item sales associated with a monitored item against each store's forecasted item sales for the monitored item in the monitored cluster to identify deviations above or below a preconfigured threshold from the stores mean forecasted sales distribution. Furthermore, analytics manager 113 evaluates each store's current and actual item sales associated with a monitored item against the actual mean distribution of actual item sales for the group as a whole to identify deviations above or below a preconfigured threshold.

The analytics manager 113 obtains a given store's forecasted item sales for a monitored item using the store's registered forecasting model 124 or system for intervals of time that extend over a time period for a current date and time to a future date and time. The store's mean distribution of actual sales are compared against the store's forecasted item sales. When the analytics manager 113 detects that a store's actual item sales fall above or below a corresponding forecasted item sales, analytics manager 113 generates an alert and provides the alert and information related to the alert within an interactive UI element presented to the user through the analytics interface 153.

Thus, analytics manager 113 not only monitors when a given store's monitored item sales deviate by a threshold amount from the monitored group's item sales for purposes of providing an alert and alert information but the analytics manager 113 also monitors a given store's monitored item sales device by a second or a same threshold amount from the store's forecasted item sales for purposes of providing an alert and alert information. To do this, analytics manager 113 processes any existing statistical-based mean calculation algorithm to determine the mean distributions for each store's monitored item sales and to determine the mean distribution for the monitored items sales of the monitored group as a whole.

The analytics manager 113 identifies any deviations beyond a threshold range or value in the monitored item's sales from a given store's mean distribution of monitored item sales and from the monitored group's mean distribution of monitored item sales as anomalies. The analytics manager 113 reports, sends, and/or transmits the anomalies as real-time alerts to one or more of the analytics interface 153, the user-operated device 150, and/or the analytics service and/or system 125.

This allows enables immediate pricing strategy adjustments by any given store of the monitored group, enables the store to implement immediate item promotion decisions with respect to the monitored item, and/or enables the store to implemented immediate item inventory decisions with respect to the monitored item. Conventional approaches cannot achieve this level of real-time alert notification and as a result conventional approaches are unable to identify situations happening in the market based on viral item posts on social media, unexpected and sudden TV advertising campaigns launched for the item, consumer reactions when the item is a new product being launched, and unexpected and sudden external events related to weather, politics, health scares, etc. Thus, system 100 via the platform provided is an improvement over conventional approaches because real-time insights into item movements (i.e., item sales) within the market place are identified and reported to stores allowing for immediate item adjustments by the stores to address current market conditions. This gives any store subscribed to the platform of system 100 a significant competitive advantage over its competitors in the marketplace with respect to any monitored item.

When stores of the monitored group as a whole are experiencing a greater degree of sales for a monitored item than a particular store of the group (e.g., as evidenced by a deviation below the preconfigured threshold), analytics manager 113 uses APIs 114 and sends a real-time alert to analytics interface 153, to a user-defined analytic service and/or system 125, and/or via a text notification to a user-operated device 150. Notably, a deviation above the actual mean distribution for the group as a whole also causes analytics manager 113 to use APIs 114 and send an alert in any of the manners discussed above.

Deviations above the threshold can be a situation at lease one store in the group had initiated a sale on the monitored item, which triggered the increased item sales and dropped a particular store's item sales. Deviations above the threshold can also be a situation in which a TV campaign or viral social media post related to the monitored item is posing a threat that immediately and dramatically changes demand for the monitored item. The particular store may want to consider increasing the monitored item's price before it runs out of inventory and thereby staying a competitive step ahead of other competitors associated with the monitored group. Deviations below the threshold can be a situation in which a corresponding store needs to know that item inventory for the monitored item needs to be inspected and perhaps the item price raised, or an existing item promotion discontinued in order to lower the excessive demand for the item and maintain inventory. Deviations above or below the threshold can be associated with a new product or item such that the stores in the monitored group and unsure how to handle inventory and pricing for the new product; deviations above the threshold can indicate the new item's price should be raised, inventory monitored closely, and/or an existing discount on the new item discontinued; deviations below the threshold can indicate the new item's price should be raised or lowered, inventory monitored, an existing item discount discontinued, and/or an item discount offered.

Currently, the industry does not provide a fine-grain and real-time evaluation of the market movement of items within user-defined groups of stores. As such, stores are unable to detect sudden increases or decreases in item sales for purposes of automatically adjusting item pricing, item discounts, and item inventory to account for what is happing within the stores. Often sudden item movements in the market start out regional and then spread within the marked at a whole, system 100 allows for timely real-time detection with a given region or grouping such that a store has an opportunity to take appropriate actions to maximize its revenue and market position.

In an embodiment, analytics manager 113 provides selectable groups for the user to subscribe to during a registration session or a management session with analytics manager 113. For example, the analytics manager 113, based on the user's store, provides a list of selectable monitored groups for which the user's store is already been associated with and clustered to. These groups, can include by way of example, convenience stores in the Atlanta area, grocery stores in the Atlanta area, Latino-based grocery stores in the Atlanta area, etc.

In an embodiment, the user defines the group criteria for a monitored group during a registration session or a management session with analytics manager 113. This was discussed above as a user-available option presented within the analytics interface 153 to the user.

Analytics manager 113 is continuously in real-time updating each monitored group's metrics for store-based item actual sales of monitored items, each store's corresponding deviations in actual item sales from forecasted item sales, and each store's actual item sales in the mean actual item sales for the group as a whole. In small increments of time or small intervals of time such as every 5 minutes any deviations above or below a store's forecasted item sales or a store's actual item sales relative to the actual item sales of the group as a whole cause analytics manager 113 to send corresponding alerts to subscribed users via message notifications to user-operated devices 150, analytic interface 153, and/or via analytic services and/or systems 125 using APIs 114.

In an embodiment, the analytics manager 113 streams the real-time updates related to a monitored item's actual sales and corresponding comparisons to a given store's forecasted sales and the monitored groups mean actual item's sales to an analytic service and/or analytic system 125 via a dashboard UI embedded within the analytic service and/or analytic system 125 using APIs 114.

In an embodiment, the analytics manager 113 uses APIs to automatically trigger inventory actions with an inventory system associated with a store of the monitored item. For example, analytics manager 113 sends an order command for the monitored item to the inventory system, which causes the inventory system to initiate a new order to have the monitored item purchased and delivered to a store for increasing inventory on the item.

In an alert, the analytics manager 113 provides the alert though interface 153 as an interactive element that visually depicts the movement or velocity of sales for a monitored item within the group. The user can interact with the interactive element to receive more in depth information such as time of day for sales, price of item, number of items sold within the monitored group within a user set time frame, etc. The information presented through the interactive element is anonymized such that no identifying information for a store of the monitored group is displayed or presented to the user. This ensures the privacy and confidentiality of each of the stores and retailers associated with the monitored group.

Some example processing scenarios with respect to system 100 are now provided for further illustration of the benefits associated with analytics manager 113. Suppose that a store manager at store X notices via a real-time dashboard interface provided by analytics manager 113 that certain items Y and Z move slower (i.e., selling less) than what has been forecasted for the store while the movement or items Y and Z has remained constant or slightly increased for the monitored group as a whole. Store manager may discover that pricing at the store has remained constant for items Y and Z leading the store manager to deduce that one or more stores in the monitored group must be discounting items Y and Z to draw customers away from the manager's store. Responsive to this, store manager may offer a comparable or better discount on items Y and Z to increase the movement on and revenues for items Y and Z.

As another example, suppose that an item category or department leader of a store notices a real-time and sudden increase in demand for item Y's sales within the store. The leader also discovers that this pattern or trend with respect to item Y is also being experienced by other stores of the group as a whole based on the alerts provided via analytics manager 113. After a little investigation, the leader discovers that there is a TV ad campaign or a social media viral post about item Y. Responsive to this situation, the leader takes inventory and pricing options into account to optimizes the store's competitive position and revenues with respect to item Y.

In yet another example, suppose a category or department leader of a store inspects the alerts and alert information provided by analytics manager 113 with respect to a new product or item Y that was only recently introduced to the industry. After inspection of the alert information, the leader discovers the supply and/or demand patterns associated with item Y in advance of other competitors within the industry and adjusts the store's inventory, pricing, and promotions with respect to store's offering of item Y resulting in a timely competitive advantage for the leader's store with respect to item Y.

In another example, suppose a category/department leader of a store inspects the alerts and alert information provided by analytics manager 113 with respect to item Y and sees a sharp spike in sales followed by a sharp drop in sales in a short period of time. The drop in sales may be due to the item being sold out and out of stock. Assuming the store has stock of the item a quick increase in item price will likely result in increased revenue for the store. The sharp rise and drop in item Y's movement is likely an indication of some external event such as a weather forecast, an impending public fear of a virus outbreak, etc.

In an embodiment, analytics manager 113 permits a store via a user during a registration session to register each item defined in the store's product catalog for monitoring. The analytics manager 113 separately manages each of the items in the product catalogue against the benchmarks based on real-time transaction data for a monitored group.

In an embodiment, the benchmarks include deviations in a given store's actual item sales that are above or below thresholds of the store's forecasted item sales for a monitored item and deviations in a given stores actual items sales that are above or below thresholds of the groups mean distribution of actual items sales for the monitored item. In an embodiment, the thresholds are configurable by the user during a registration session or during a management session with analytics manager 113.

In an embodiment, the user can set a user-defined benchmark during a registration session or management session with analytics manager 113. For example, suppose the user wants an alert or real-time notification when sales of a monitored item increase by X % for the group as a whole regardless as to whether the store associated with the user has a comparable increase in monitored item sales. This may be used by the user to increase inventory for the monitored item and/or simultaneously increase inventory of the monitored item while running a promotion for the monitored item.

In an embodiment, analytics manager 113 provides interface options within analytics interface 153 for the user to custom applying benchmarking filters to the alert information. For example, suppose the user wants to view item sales or movement of the item within the group based on a user defined time window, user defined day of week, etc. The analytics manager 113 permits these user-defined benchmarking filters to be applied to the monitored group within the alert information as an interactive element as discussed above.

System 100 distinguishes over conventional approaches by providing a timely, accurate, and customizable benchmarking alerts to a given store regarding item sales or movement within a monitored group of stores. This is done while maintaining each of the store's anonymity with respect to competitive item sales data and achieved through a benchmarking platform provided by analytics manager 113. Transaction data and forecasting data are integrated and anonymized, which encourage non-subscribing stores to participate and subscribe to the benchmarking features of system 100 to further enhance ongoing accuracy of the benchmarking alerts associated with the integrated data. Furthermore, the benchmarking platform is external to the processing environments of the stores and retailers and is easily scaled to handle more subscribing stores without impacting response times and while simultaneously improving the accuracy of the provided alerts.

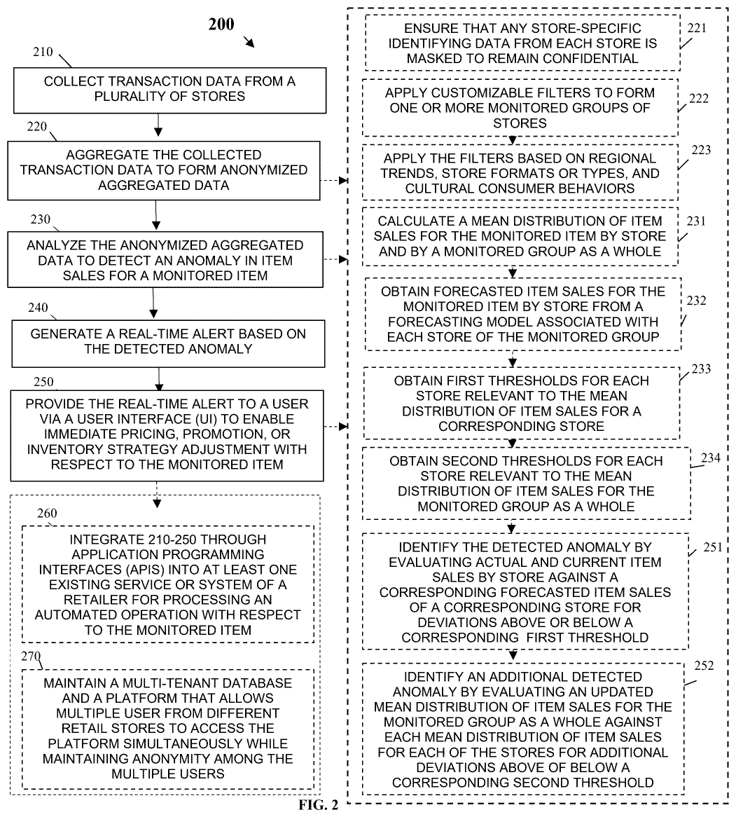

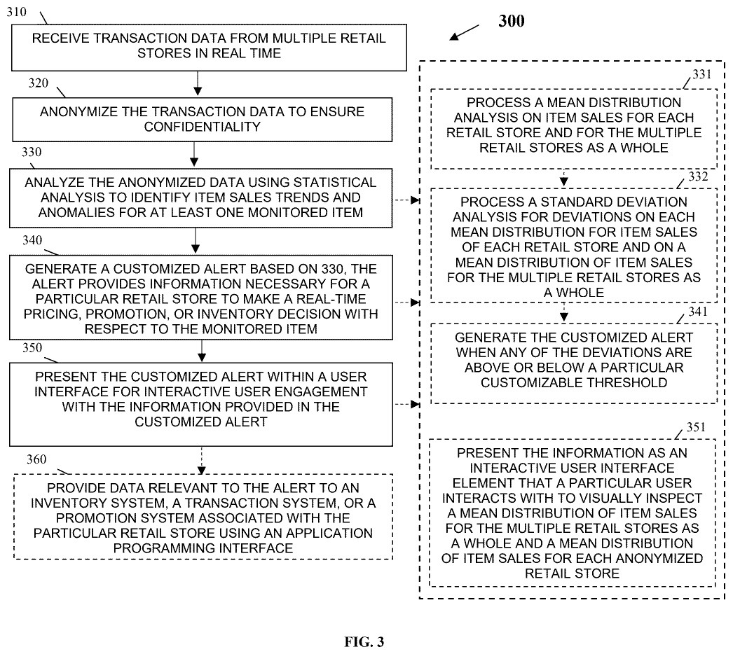

These and other embodiments are now discussed with reference to the FIGS. 2-3. FIG. 2 is a diagram of a method 200 for operating or providing dynamic retail analytics platform, according to an example embodiment. The software module(s) that implements the method 200 is referred to as a “real-time pricing alert manager.” The real-time pricing alert manager is implemented as executable instructions programmed and residing within memory and/or a non-transitory computer-readable (processor-readable) storage medium and executed by one or more processors of a device. The processor(s) of the device that executes the real-time pricing alert manager are specifically configured and programmed to process the real-time pricing alert manager. The real-time pricing alert manager has access to one or more network connections during its processing. The network connections can be wired, wireless, or a combination of wired and wireless.

In an embodiment, the device that executes the real-time pricing alert manager is a cloud 110 or cloud server 110. In an embodiment, the cloud 110 is a processing environment that includes multiple servers cooperating with one another as a single logical server. In an embodiment, the real-time pricing alert manager is all of or some combination of 113 and/or 114. In an embodiment, the real-time pricing alert manager is provided as a SaaS to a plurality of retailers, each retailer having a subscription to cloud 110.

At 210, the real-time pricing alert manager collects transaction data from a plurality of different stores. In an embodiment, the real-time pricing alert manager uses APIs 114 to interface with terminals 130 and transaction systems 123 to receive and collect the transaction data in real time and dynamically as in-store transaction and on-line transactions are processed by the stores.

At 220, the real-time pricing alert manager aggregates the collected transaction data to form anonymized aggregated data. In an embodiment, at 221, the real-time pricing alert manager ensures that any store-specific identifying data within the anonymized aggregated data is masked, inaccessible, and non-viewable for each store ensuring that transaction data for each store remains confidential within the anonymized aggregated data. This prevents any given store from viewing transaction data associated with a different store represented within the anonymized aggregated data.

In an embodiment, at 222, the real-time pricing alert manager applies customizable filters against the anonymized aggregated data to form one or more separately monitored groups or clusters of the stores. In an embodiment, a single store can participate in more than one monitored group and in such a case the real-time pricing alert manager replicates transaction data associated with the store to each of the store's subscribed monitored groups.

In an embodiment of 222 and at 223, the real-time pricing alert manager applies the filters based on regional trends, store formats or types, and cultural consumer behaviors. As an example, a regional trend includes a zip code, a city, a set of street addresses, and area bounded by streets, etc. A store format includes a big box store, a grocery store, a department store, a convenience store, a high-end specialty store. Cultural consumer behaviors include a Latin America store, an Asian store, a kosher store, etc.

At 230, the real-time pricing alert manager analyzes the anonymized aggregated data to detect an anomaly in item sales for a monitored item. In an embodiment, at 231, the real-time pricing alert manager calculates a mean distribution of item sales for the monitored item by store and by a monitored group as a whole representing all of the stores.

In an embodiment of 231 and at 232, the real-time pricing alert manager obtains forecasted item sales for the monitored item by store from a forecasting model 124 associated with each store of the monitored group. In an embodiment of 232 and at 233, the obtains forecasted item sales for the monitored item by store from a forecasting model 124 associated with each store of the monitored group obtains first thresholds for each store relevant to the mean distribution of item sales for a corresponding store. In an embodiment of 233 and at 234, the obtains forecasted item sales for the monitored item by store from a forecasting model 124 associated with each store of the monitored group obtains second thresholds for each store relevant to the mean distribution of item sales for the monitored group as a whole.

At 240, the real-time pricing alert manager generates a real-time alert based on the detected anomaly of 230. The anomaly associated with at least one store's item sales.

At 250, the real-time pricing alert manager provides the real-time alert to a user via a user interface (e.g., analytics interface 153) to enable immediate pricing, promotion, and/or inventory strategy adjustment with respect to the monitored item. That is, the user reacts to the real-time alert to make an adjustment with respect to the monitored item. The adjustment includes raising or lowering a price of the item, instituting a new promotion on the item, discontinuing an existing promotion on the item, ordering additional inventory on the item, or canceling/modifying inventory orders on the item.

In an embodiment of 234 and 250, at 251, the real-time pricing alert manager identifies the detected anomaly by evaluating actual and current item sales by store against a corresponding forecasted item sales of a corresponding store for deviations above or below a corresponding first threshold. In an embodiment of 252 and at 252, the real-time pricing alert manager identifies an additional detected anomaly by evaluating an updated mean distribution of item sales that accounts for the actual and current item sales of the monitored group for the monitored group as a whole against each mean distribution of item sales for each of the stores for additional deviations above or below a corresponding second threshold.

In an embodiment, at 260, the real-time pricing alert manager (i.e., 210-250) is integrated through APIs 114 into at least one existing service or system of a retailer for processing an automated operation with respect to the monitored item and the pricing, promotion, or inventory strategy adjustment. In an embodiment, the existing service or system is the analytics service or system 125. In an embodiment, the existing system is an inventory system, a loyalty system, a promotion system, or the transaction system 123.

In an embodiment, at 270, the real-time pricing alert manager maintains a multi-tenant database and platform that allows multiple users from different retail stores to access the platform simultaneously while maintaining anonymity among the multiple users. Each store's transaction data is also anonymized as discussed above at 230 such that a user associated with a store cannot discern transaction data from a different store associated with a different user.

FIG. 3 is a diagram of another method 300 for operating or providing dynamic retail analytics platform, according to an example embodiment. The software module(s) that implements the method 300 is referred to as a “pricing analytics manager.” The pricing analytics manager is implemented as executable instructions programmed and residing within memory and/or a non-transitory computer-readable (processor-readable) storage medium and executed by one or more processors of a device. The processors that execute the item pricing analytics manager are specifically configured and programmed to process the pricing analytics manager. The pricing analytics manager has access to one or more network connections during its processing. The network connections can be wired, wireless, or a combination of wired and wireless.

In an embodiment, the device that executes the pricing analytics manager is a cloud 110 or a cloud server 110. In an embodiment, the cloud is a processing environment that comprises multiple servers cooperating with one another as a single logical server.

In an embodiment, the item pricing analytics manager is all or some combination of 113, 114, and/or the method 200. The pricing analytics manager presents another and, in some ways, enhanced processing perspective to that which was described above with the method 200 of FIG. 2.

At 310, the pricing analytics manager collects transaction data from a plurality of stores. The pricing analytics manager continuously receives, and updates transaction collected transaction data from each of the stores as transactions are processed by transaction managers 133 of terminals 130 for in-store transactions and by transaction systems 123 of retail servers 120 for online transactions.

At 320, the pricing analytics manager anonymizes the transaction data to ensure confidentiality. That is, any store identifying information within the collected transaction data is masked or hidden such that users associated with the stores are unable to discern a specific competitor's transaction data from the anonymized transaction data.

At 330, the pricing analytics manager analyzes the anonymized data using statistical analysis to identify item sales trends and anomalies for at least one monitored item. In an embodiment, at 331, the pricing analytics manager processes a mean distribution analysis on item sales for each retail store and for the multiple retail stores as a whole. In an embodiment of 331 and at 332, the pricing analytics manager processes a standard deviation analysis for deviations on each mean distribution for item sales of each retail store and on a mean distribution of item sales for the multiple retail stores as a whole.

At 340, the pricing analytics manager generates a customized alert based on 330. The customized alert provides information necessary for a particular retail store to make a real-time pricing, promotion, or inventory decision with respect to the monitored item. In an embodiment of 332 and 340, at 341, the pricing analytics manager generates the customized alert when any of the deviations are above or below a particular customizable threshold.

At 350, the pricing analytics manager presents the customized alert within a user interface for interactive user engagement with the information provided in the customized alert. In an embodiment the user interface is the analytics interface 153. In an embodiment, at 351, the pricing analytics manager presents the information as an interactive user interface element that a particular user interacts with to visually inspect a mean distribution of item sales for the multiple retail stores as a whole and a mean distribution of item sales for each anonymized retail store.

In an embodiment, at 360, the pricing analytics manager provides data relevant to the alert to an inventory system, a transaction system 123 or a promotion system associated with the particular retail store using an API 114. Here, the data causes the corresponding system to perform an automated action or operation with respect to pricing, inventory, or promotion relevant to the monitored item.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
collecting transaction data from a plurality of stores;
aggregating the collected transaction data to form anonymized aggregated data;
analyzing the anonymized aggregated data to detect an anomaly in item sales for a monitored item;
generating a real-time alert based on the detected anomaly; and
providing the real-time alert to a user via a user interface (UI) to enable immediate pricing, promotion, or inventory strategy adjustment with respect to the monitored item.

2. The method of claim 1, wherein aggregating further includes ensuring that any store-specific identifying data from each store represented in the collected transaction data is masked to remain confidential and anonymous within the anonymized aggregated data.

3. The method of claim 1, wherein aggregating further includes applying customizable filters to the anonymized aggregated data to form one or more monitored groups of stores.

4. The method of claim 3, wherein applying further includes applying customized filters to form the one or more monitored groups based on filters associated with regional trends, store formats or types, and cultural consumer behaviors.

5. The method of claim 1, wherein analyzing further includes calculating and maintaining a mean distribution of item sales for the monitored item by store and by a monitored group as a whole.

6. The method of claim 5, wherein analyzing further includes obtaining forecasted item sales for the monitored item by store from a forecasting model associated with each store of the monitored group.

7. The method of claim 6, wherein obtaining further includes obtaining first thresholds for each store relevant to the mean distribution of item sales for a corresponding store.

8. The method of claim 7, wherein obtaining further includes obtaining second thresholds for each store relevant to the mean distribution of item sales for the monitored group as a whole.

9. The method of claim 8, wherein generating further includes identifying the detected anomaly by evaluating actual and current item sales by store against a corresponding forecasted item sales of a corresponding store for deviations above or below a corresponding first threshold.

10. The method of claim 9, wherein generating further includes identifying an additional detected anomaly by evaluating an updated mean distribution of item sales for the monitored group as a whole that accounts for the actual and current item sales of the monitored group as a whole against each mean distribution of item sales for each of the stores for additional deviations above or below corresponding a corresponding second threshold.

11. The method of claim 1, further comprising integrating the method through application programming interfaces into existing services or existing systems of a retailer for an automated pricing, promotion, or inventory operation with respect to the monitored item.

12. The method of claim 11, further comprising maintaining a multi-tenant database that allows multiple users from different retail stores to access a platform simultaneous while maintaining data anonymity among the multiple users.

13. A method, comprising:
receiving transaction data from multiple retail stores in real time;
anonymizing the transaction data to ensure confidentiality;
analyzing the anonymized data using statistical analysis to identify item sales trends and anomalies for at least one monitored item;
generating a customized alert based on the analyzing, wherein the alerts provide information necessary for a particular retail store to make a real-time pricing, promotion, and inventory decision with respect to the monitored item; and
presenting the customized alert within a user interface for interactive user engagement with the information provided in the customized alert.

14. The method of claim 13, wherein analyzing further includes processing mean distribution analysis on item sales for each retail store and for the multiple retail stores as a whole.

15. The method of claim 14, wherein analyzing further includes processing a standard deviation analysis for deviations on each mean distribution for item sales of each retail store and on a mean distribution of item sales for the multiple retail stores as a whole.

16. The method of claim 15, wherein generating further includes generating the customized alert when any of the deviations are above or below a particular customizable threshold.

17. The method of claim 13, wherein presenting further includes rendering the information as an interactive user interface element that a particular user interacts with to visually inspect a mean distribution of item sales for each store and a mean distribution of item sales for the multiple retail stores as a whole and a mean distribution of item sales for each anonymized retail store.

18. The method of claim 13, further comprising providing data relevant to the alert to an inventory system, a transaction system, or a promotion system associated with the particular retail store using an application programming interface.

19. A system, comprising:
at least one processor configured to execute instructions from a non-transitory computer-readable storage medium; and
the instructions when executed by the at least one processor from the non-transitory computer-readable storage medium cause the at least processor to perform operations comprising:
collecting transaction data in real time from a plurality of terminals and transaction systems associated with multiple retailers;
aggregating the transaction data into monitored groups of the multiple retailers based on applying user-defined filters;
anonymizing the aggregated transaction data of each monitored group to prevent corresponding transaction data from being associated with any particular store;
processing statistical analysis on the transaction data of each monitored group to detect anomalies in sales of a monitored item with respect to each retailer associated with a corresponding monitored group; and
providing an alert to a particular retailer associated with a particular monitored group based on a particular detected anomaly.

20. The system of claim 19, wherein the instructions for the providing further cause the at least one processor to perform additional operations comprising:
providing the alert with information as an interactive element within a user interface for interaction by a user to inspect and initiate a pricing, promotion, or inventory decision with respect to the monitored item.
